(19) United States
(12) Patent Application Publication
(10) Pub. No.: US 2009/0298360 A1
(43) Pub. Date: Dec. 3, 2009

(54) Paddle Track

(76) Inventor: Laura Lee Chippas, West Palm Beach, FL (US)

Correspondence Address: Laura Chippas, 15170 70th Trail North, West Palm Beach, FL, 33418, US

(21) Appl. No.: 12/388,000

(22) Filed: Jun. 29, 2009

Related U.S. Application Data
(60) Provisional application No. 61/130,123, filed on May 28, 2008.

(51) Int. Cl. B63H 19/08; B60F 3/00; B63H 19/00

(52) U.S. Cl. 440/12.63

(57) ABSTRACT

The present invention relates to amphibian vehicles, more particularly to track paddling propulsion. The present application is a copy of drawings submitted as a provisional patent application No. 61/130,123 filing date May 28, 2008 confirmation no. 1620.

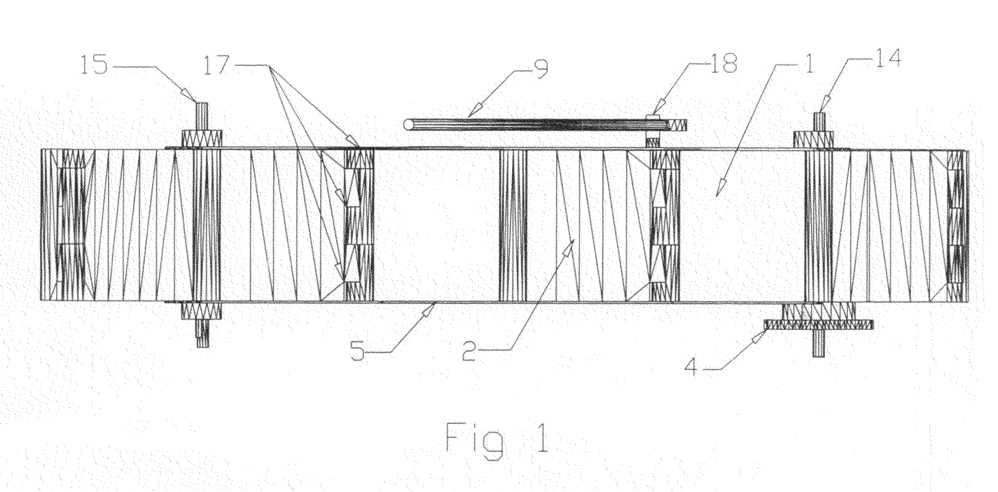

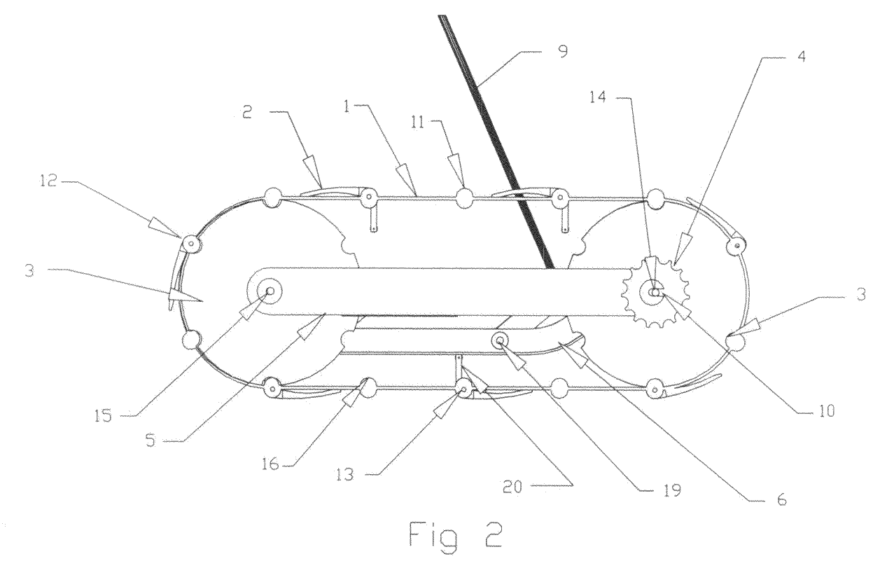

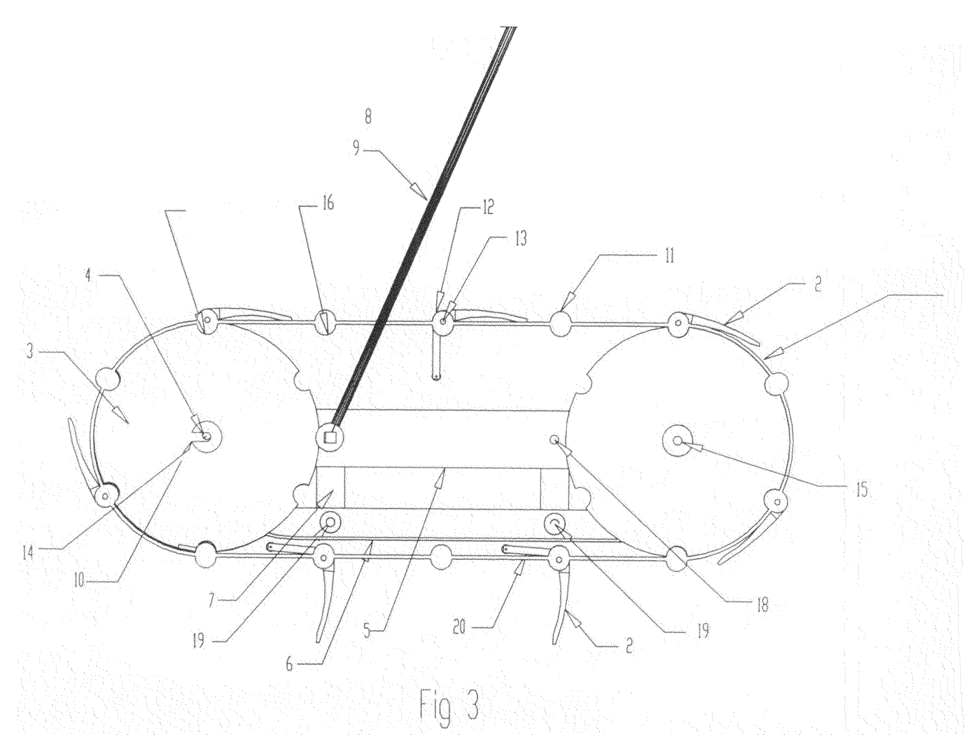

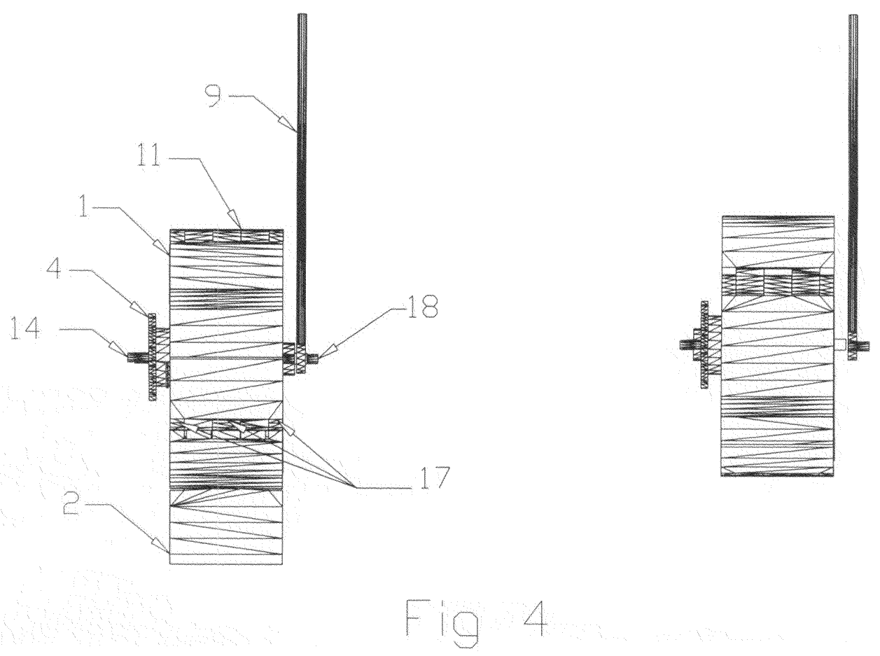

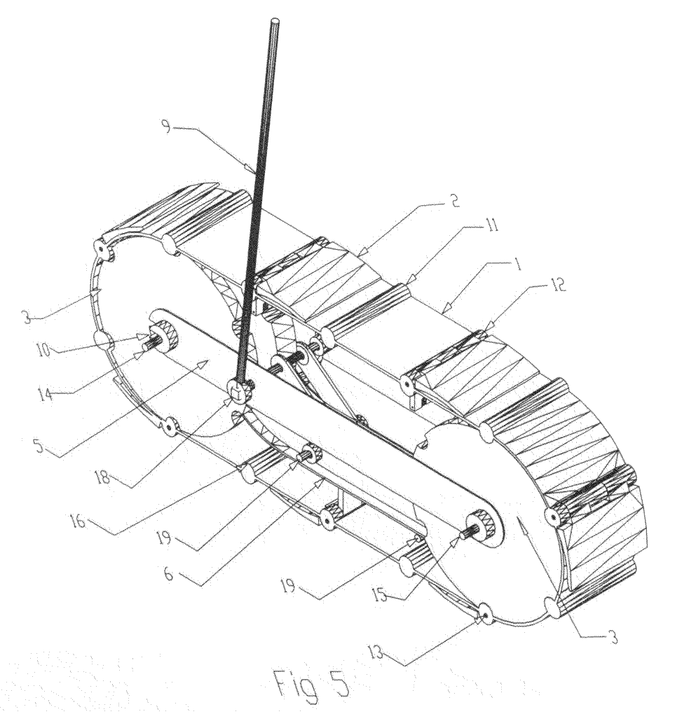

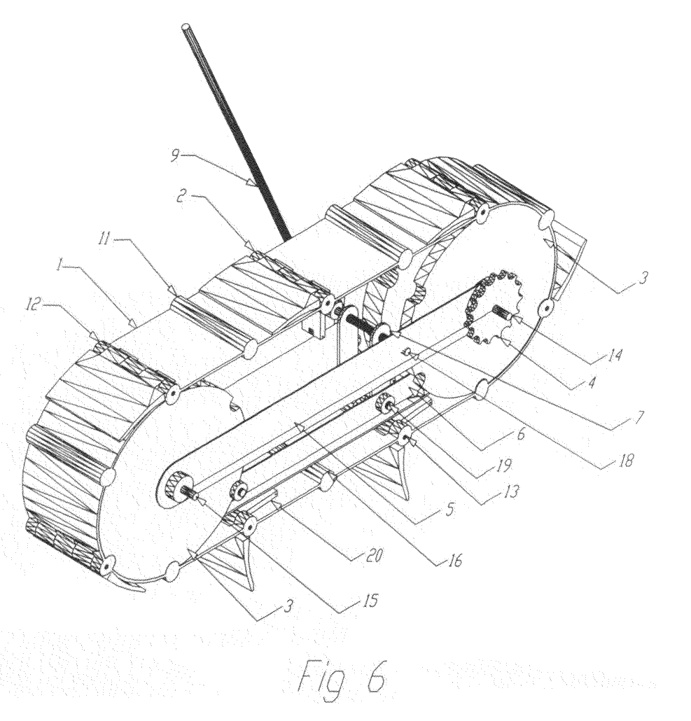

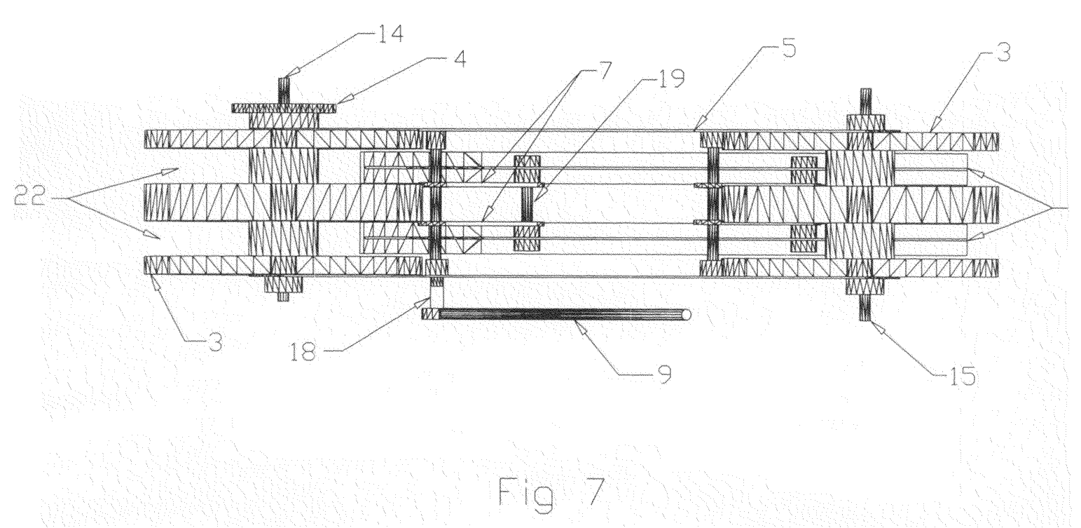

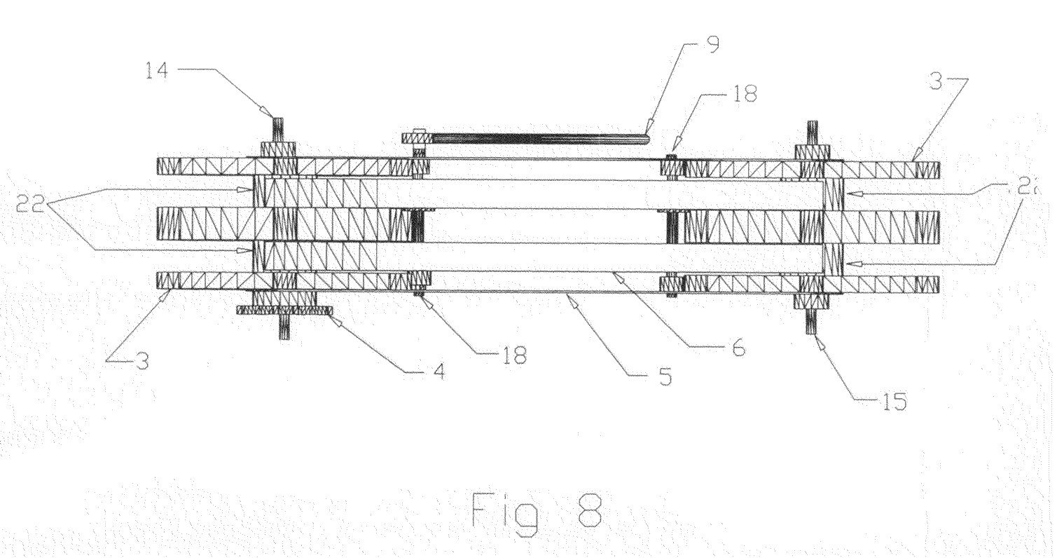

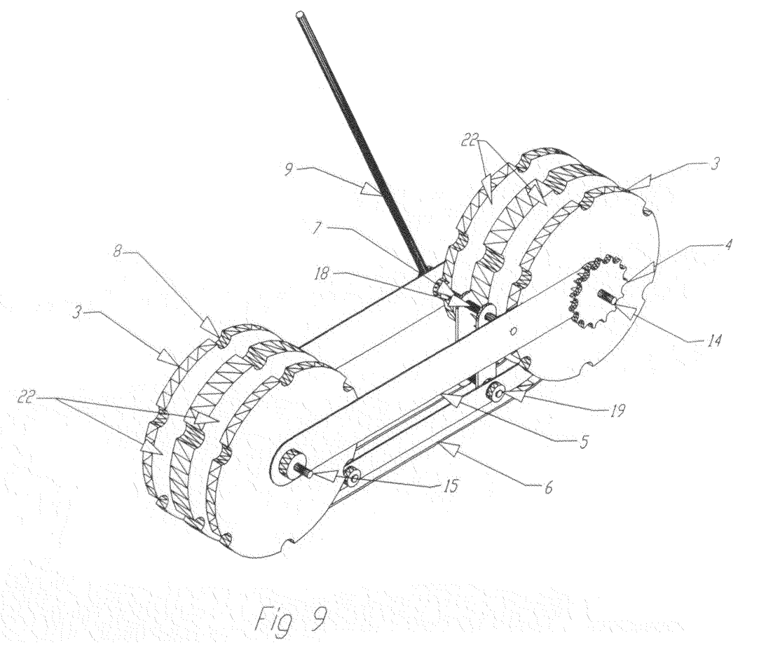

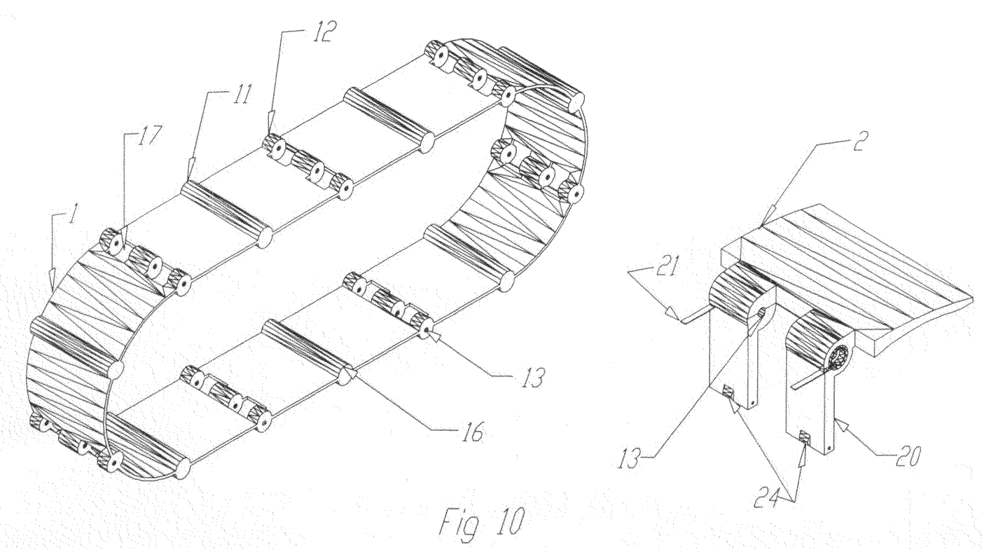

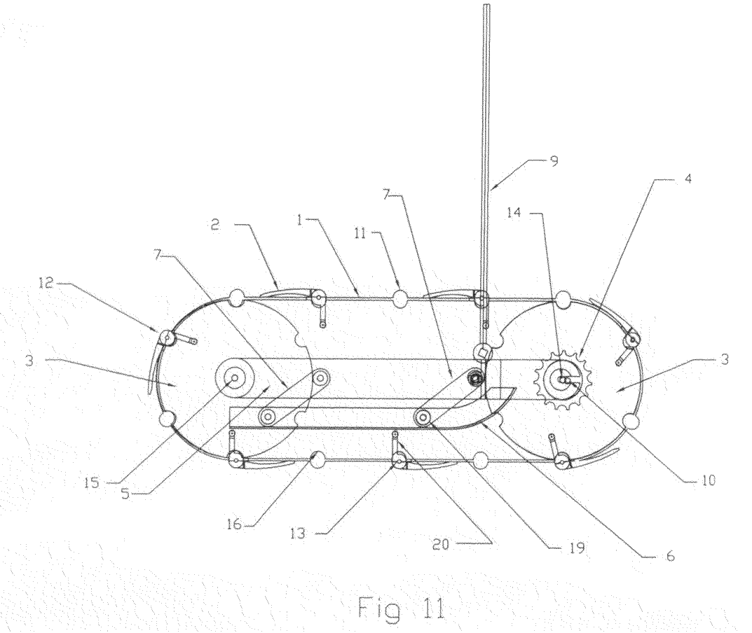

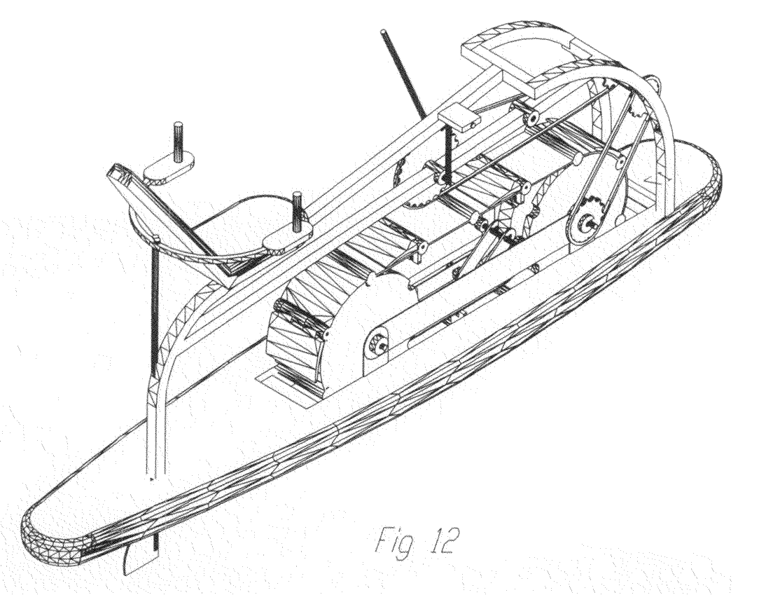

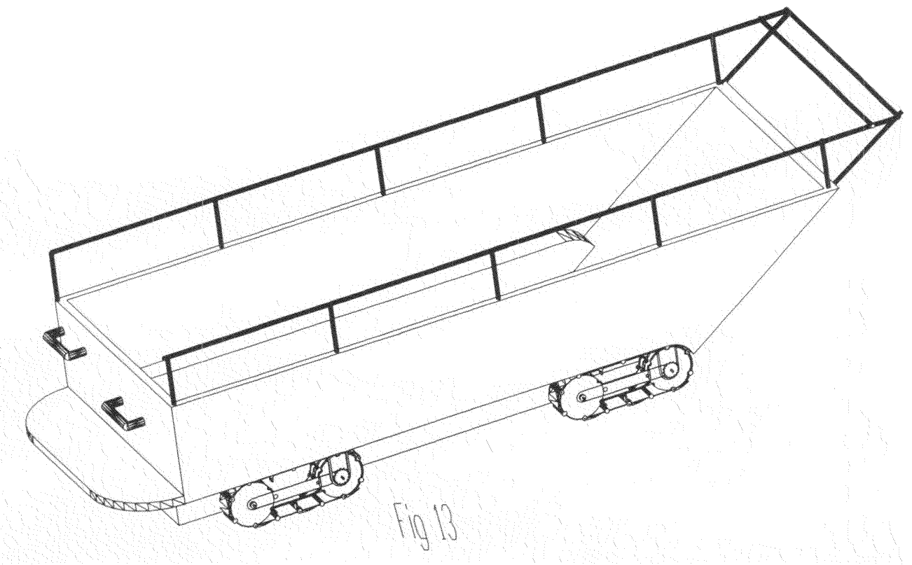

The object of the invention is to provide a novel means of amphibian locomotion via track retractable paddling. The paddle track apparatus can be installed on a single floater for use as a water cycle or a vehicle floater having paddle tracks on opposite sides (port and starboard) for whatever use is desired. Locomotion power is either pedaling or motorized. In essence this apparatus is to provide a means of locomotion for any type of amphibian or water bound locomotion.

The present invention relates to amphibian vehicles, more particularly to track paddling propulsion. The present application is a copy of drawings submitted as a provisional patent application No. 61/131,123 filing date Jun. 9, 2008 confirmation no. 7119. Names of applicants, Laura Chippas Ross, Linda Reilly, and William J. Evans. Title of invention, Paddle Track.

### BACKGROUND OF THE INVENTION

1. Field of the Invention

The object of the invention is to provide a novel means of amphibian locomotion via track retractable paddling. The paddle track apparatus can be installed on a single floater for use as a water cycle or a vehicle floater having paddle tracks on opposite sides (port and starboard) for whatever use is desired. Locomotion power is either pedaling or motorized. In essence this apparatus is to provide a means of locomotion for any type of amphibian or water bound locomotion.

2. Related Art

Numerous devices/vehicles are known for use of water-land locomotion. These devices commonly use some type of paddles or tracks for locomotion. For example, U.S. Pat. No. 5,226,843 to Yun discloses a depiction of an amphibian cycle, which the rear wheel has a series of paddles for locomotion mounted on floaters.

U.S. Pat. No. 4,511,338 to Fanelli discloses a depiction of a cycle configuration on a floater and paddles on port and starboard for locomotion.

U.S. Pat. No. 2,416,128 to Swennes discloses a depiction of an amphibian track vehicle which depends on a series of treads for locomotion.

U.S. Pat. No. 2,916,006 to Crandall discloses a depiction of an amphibian with a series of wheels for locomotion.

U.S. Pat. No. 2,878,883 to France discloses a depiction of a track mounted on two wheels and the track having a series of treads propelled by a propeller.

U.S. Pat. No. 6,083,065 to Hall discloses a depiction of a paddle configuration mounted xxxxx a boat.

U.S. Pat. No. 3,353,618 to Fisher discloses a depiction of an amphibian having a track revolving on two wheels and the track having a series of treads for locomotion Many of these devices/vehicle, such as those of Yun, Fanelli, Swennes et al., Crandall et al., France et al., Hall and Fisher are all intended of some sort of amphibian or amphibian to land locomotion's, however none of which relates to the present invention therefore, it is primary object of the invention to provide a device for water-land locomotion that operates uniquely.

It is therefore to be understood that, within the scope of the appended claims and their equivalents, the invention may be practiced otherwise than as specifically described.

### SUMMARY OF THE INVENTION

A paddle track propulsion system includes a paddle track mounted for rotation about its horizontal axes for propelling a vessel or a cycle. Having an elongated frame which the leading edge of the frame receives a drum gear sprocket with a chain sprocket attached to said drum gear sprocket and the trailing end of the frame receiving a drum gear sprocket for rotation. A paddle track is mounted on the drum gear sprockets for rotation. Paddle track propulsion includes a flexible or hinged track and having paddles mounted on said track capable of hinging ninety degrees (90) to engage water or terrain locomotion. The frame, also housing a mechanism for engaging and disengaging the paddles for water or terrain locomotion. A selecting lever engages and disengages the paddles. The paddle track can be mounted on a floating vessel or a cycle it is therefore a primary object of the invention to provide a means of amphibian locomotion via paddle track whereas, the paddle maintains a parallel position to the track for terrain locomotion and can be triggered to a perpendicular position for water locomotion.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described and certain features may be used independently or other features and the number and configuration of various paddle track components described above may be altered without departing from the spirit or scope of the invention as defined in the appended claims.

Reference Cited
U.S. Patent Documents

| | | |
|---|---|---|
| 5,226,843 | Jul. 13, 1993 | Yun |
| 4,511,338 | Apr. 16, 1985 | Fanelli |
| 2,416,128 | Feb. 18, 1947 | Borg-Warner Corp. |
| 2,916,006 | Dec. 08, 1959 | Crandall |
| 2,8t8,883 | Mar. 24, 1959 | France etc |
| 3,353,618 | Nov. 21, 1965 | Fisher |
| 6,083,065 | Jul. 04, 2000 | Hall |

After searching the U.S. Patent Office data these inventors found nothing remotely related to this paddle track now before the U.S. Patent Office Examiner.

### BRIEF DESCRIPTION OF THE DRAWINGS

The intent of the invention will become clear by the following description of the present invention with reference to the accompanying drawings.

No. 1 The Paddle Track 1 being elongated horizontally of a given length and width and made of flexible or hinged material capable of rotating around the drum gear sprocket 3. The paddle track 1 has a series of circular treads 11 traversing the outer perimeter of the paddle track 1 at a given distance apart and a given number of terrain treads 11 have a cut out configuration 17 to secure the paddle 2 (see drawing 10). The inside perimeter of the paddle track 1 has a series of circular gear teeth 16 having the same pitch diameter as the drum gear sprocket 3 (see drawing 10).

No. 2 The paddle 2 having X axes which is the paddle 2, Y axes which is the paddle engager 20 and Z axes which is the hinging element 12 of the paddle. The Z axes of the paddle 2 having a hinge hole 13 traversing X, Y axes for the purpose of securing the paddle for hinging (see drawing 10).

No. 3 The drum gear sprocket 3 having a given diameter and a given depth on the z-axes is hermetically sealed for buoyancy. The drum gear sprocket 3 is configured with a series of circular pitch diameter 8 traversing the circumference of the drum gear sprocket 3. The drum gear sprocket 3 is also configured with two inner spacings 22 along the y-axes of the drum gear sprocket 3 and a width along the z-axes to accommodate the paddle engager 20. The drum gear spacings 22 provide the means of the paddle engager 20 to rotate within the spacings 22 and maintain the paddle 2 parallel on the top portion of the paddle track perpetually. The drum sprocket 3 having an axle hole traversing the center of its axes (see drawings 7, 8 and 9).

No. 4 The chain sprocket 4 mounted on the front axle 14 to rotate the drum gear sprocket 3. The chain sprocket 4 having the same pitch as the link chain and being driven by a power source.

No. 5 The frame is an elongated frame along the horizontal axes of a given length and width and has the configuration to house the components of the paddle track.

No. 6 The engaging beams being a pair of “T” beams with the top of the tee utilized for the paddle engager 20 rollers to travel upon. The leading edges of the engaging beams having an upward curvature to trigger the paddle engager 20 vertically as it contacts the engaging beams 6. The engaging beams 6 function by lowering the engaging beams 6 a given distance to allow only the thickness of the paddle engager 20 to ravel the length of the engaging beams sandwiched between the track 1 and the engaging beams 6 and maintain the paddle 2 for water locomotion (see drawings 2 and 3).

No. 7 The cams engaging brackets 7 on opposite sides are mounted to the frame with a shaft traversing their axes for arc movement. The lower section of the cam is attached to the engaging beam 6 and the upper section is fixed to an engaging selector 9, which creates an arc movement for engaging and disengaging by lowering and lifting the paddles 2.

No. 8 Illustrates the drum gear sprocket circular pitch 8.

No. 9 Engaging selector 9 is a rod perpendicular to the frame 5 fixed to the cam 18 and by moving it forward or rearward engages and disengages.

No. 10 The adjusting slot is to adjust the tension of the track.

No. 11 The terrain 11 treads traversing the paddle track are at a given distance apart on the outside periphery of the track and circular in shape for the purpose of terrain traction and a number of the terrain treads are utilized for hinging the paddle.

No. 12 The paddle hinge 12 is a cutout 17 in the paddle track 1 and configured to receive and mate with the paddle 2 configuration for hinging. (See drawing 10)

No. 13 The hinge hole is the means of securing the paddle 2 to the track 1.

No. 14 The front axle 14 traversing the frame, drum gear sprocket, and the chain sprocket for rotation.

No. 15 The rear axle 15 traversing the rear frame 5 and the drum sprocket 3 axes.

No. 16 The track circular teeth 16 correspond and mesh with the drum sprocket 3 for rotation.

No. 17 The track 17 has cutout configuration that receives the paddle 2 for hinging. (See drawing 10)

No. 18 The shaft 18 is fixed to the engaging arm 9 and engaging brackets 7 for lifting and lowering the engaging beam 6.

No. 19 The shaft 19 is traversing the engaging beams 6 and the cam brackets 7 allowing rotational movement for engaging and disengaging the paddle 2.

No. 20 The paddle engager 20 causing the paddle 2 to engage and disengage.

No. 21 Torque springs having the right amount of torque to maintain the paddle 2 parallel to the paddle track 1 (see drawing 10).

No. 22 The drum spacing 22 on the drum sprocket 3 allow the paddle engager 20 to pass and remain parallel to the track as it rotates.

No. 23 The track hinge holes 23 are for the purpose of securing the paddle 2 via a hinge shaft to the paddle track 2.

No. 24 Rollers at the trailing end of the paddle engager 20 are for the purpose of negating dragging along the bottom of the engaging beams 6 (see drawing 3).

### BRIEF DESCRIPTION OF THE DRAWINGS

1. TRACK
2. PADDLE
3. DRUM GEAR SPROCKETS
4. CHAIN SPROCKET
5. FRAME
6. ENGAGING BEAM
7. ENGAGING CAM BRACKETS (SEE DRAWING 11 WIRE FRAME)
8. DRUM SPROCKET CIRCULAR PITCH CORRESPONDS TO THE TRACK (MESHES)
9. SELECTOR
10. ADJUSTING SLOT
11. TERRAIN TREAD
12. PADDLE HINGE
13. HINGE HOLE
14. FRONT AXLE
15. REAR AXLE
16. TRACK CIRCULAR TEETH
17. CUT-OUTS (SEE DRAWING 10)
18. SHAFT ENGAGING (SEE DRAWING 7,8)
19. SHAFT RAVERSING ENGAGING BEAMS (SEE DRAWING 7,8)
20. PADDLE ENGAGER (SEE DRAWING 2,3)
21. TORQUE SPRINGS (SEE DRAWING I 0)
22. SPACINGS IN DRUM SPROCKET (SEE DRAWING 7,8) ENGAGING CAM BRACKETS
23. TRACK HINGE HOLE
24. ROLLERS

1 The Paddle Track 1 being elongated horizontally of a given length and width and made of flexible or hinged material capable of rotating the drum gear sprocket 3. The paddle track 1 has a series of circular treads 11 traversing the outer perimeter of the paddle track 1 at a given distance apart and a given number of terrain treads 11 have a cut out configuration 17 to secure the paddle 2 (see drawing 10). The inside perimeter of the paddle track 1 has a series of circular gear teeth 16 having the same pitch diameter as the drum sprocket 3 (see drawing 10).

2 The paddle 2 having X axes which is the paddle 2, Y axes which is the paddle engager 20 and Z axes which is the hinging element 12 of the paddle. The Z axes of the paddle 2 having a hinge hole 13 traversing X, Y axes for the purpose of securing the paddle for hinging (see drawing 10).

3 The drum gear sprocket 3 having a given diameter and a given depth on the z-axes is hermetically sealed for buoyancy. The drum gear sprocket 3 is configured with a series of circular pitch diameter 8 traversing the circumference of the drum gear sprocket 3. The drum gear sprocket 3 is also configured with two inner spacings 22 along the y-axes of the drum gear sprocket 3 and a width along the z-axes to accommodate the paddle engager 20. The drum gear spacings 22 provide the means of the paddle engager 20 to rotate within the spacings 22 and maintain the paddle 2 parallel on the top portion of the paddle track perpetually. The drum sprocket 3 having an axle hole traversing the center of its axes (see drawings 7,8 and 9).

4 The chain sprocket 4 mounted on the front axle 14 to rotate the drum gear sprocket 3. The chain sprocket 4 having the same pitch as the link chain and being driven by a power source.

5 The frame is an elongated frame along the horizontal axes of a given length and width and has the configuration to house the components of the paddle track.

6 The engaging beams being a pair of “T” beams with the top of the tee utilized for the paddle engager 20 rollers to travel upon. The leading edges of the engaging beams having an upward curvature to trigger the paddle engager 20 vertically as it contacts the engaging beams 6. The engaging beams 6 function by lowering the engaging beams 6 a given distance to allow only the thickness of the paddle engager 20 to ravel the length of the engaging beams sandwiched between the track 1 and the engaging beams 6 and maintain the paddle 2 for water locomotion (see drawings 2 and 3).

7 The cams engaging brackets 7 on opposite sides are mounted to the frame with a shaft traversing their axes for arc movement. The lower section of the cam is attached to the engaging beam 6 and the upper section is fixed to an engaging selector 9, which creates an arc movement for engaging and disengaging by lowering and lifting the paddles 2.

8 Illustrates the drum gear sprocket circular pitch 8.

9 Engaging selector 9 is a rod perpendicular to the frame 5 fixed to the cam 18 and by moving it forward or rearward engages and disengages.

10 The adjusting slot is to adjust the tension of the track.

11 The terrain 11 treads traversing the paddle track are at a given distance apart on the outside periphery of the track and circular in shape for the purpose of terrain traction and a number of the terrain treads are utilized for hinging the paddle.

12 The paddle hinge 12 is a cutout 17 in the paddle track 1 and configured to receive and mate with the paddle 2 configuration for hinging.

13 The hinge hole is the means of securing the paddle 2 to the track 1.

14 The front axle 14 traversing the frame drum gear sprocket and the chain sprocket for rotation.

15 The rear axle 15 traversing the rear frame 5 and the drum sprocket 3 axes.

16 The track circular teeth 16 correspond and mesh with the drum sprocket 3 for rotation.

17 The track 17 has cutout configuration that receives the paddle 2 for hinging.

18 The shaft 18 is fixed to the engaging arm 9 and engaging brackets 7 for lifting and lowering the engaging beam 6.

19 The shaft 19 traversing the engaging beams 6 and the cam brackets 7 allowing rotational movement for engaging and disengaging the paddle 2.

20 the paddle engager 20 causing the paddle 2 to engage and disengage.

21 Torque springs having the right amount of torque to maintain the paddle 2 parallel to the paddle track 1 (see drawing 10).

22 The drum spacing 22 on the drum sprocket 3 allows the paddle engager 20 to pass and remain parallel to the track as it rotates.

23 The track hinge holes 23 are for the purpose of securing the paddle 2 via a hinge shaft to the paddle track 2.

24 Rollers at the trailing end of the paddle engager 20 are for the purpose of negating dragging along-the bottom of the engaging beams 6 (see drawing 3).

1. What we claim as our invention is there is no other retractable paddle track propulsion system as referenced in the related art comparisons herein. The Paddle Track clearly has no equal based on the research of the other patent's that have similar concepts but entirely different means of operating. This is our claim.
